(19) United States
(12) Patent Application Publication
(10) Pub. No.: US 2015/0080114 A1
(43) Pub. Date: Mar. 19, 2015

(54) SECURITY FOR ELECTRONIC WAGER TRANSACTIONS

(71) Applicants: Eddie Raymond Tipton, Norwalk, IA (US); Edward James Stefan, Norwalk, IA (US)

(72) Inventors: Eddie Raymond Tipton, Norwalk, IA (US); Edward James Stefan, Norwalk, IA (US)

(21) Appl. No.: 14/464,227

(22) Filed: Aug. 20, 2014

Related U.S. Application Data
(60) Provisional application No. 61/879,432, filed on Sep. 18, 2013.

(51) Int. Cl. G07F 17/32; G06Q 50/34

(52) U.S. Cl. CPC G07F 17/3241; G06Q 50/34
USPC 463/25

(57) ABSTRACT

A method is provided for detecting when tampering has occurred on a wager or transaction by using a digital signature created using the transaction details while including one or more previous transactions and an optional control or marker transaction. The pattern of selecting previous transactions can be static or dynamically modifiable and control transactions may occur in a random or pre-determined scheme to create a known baseline for previous and future transactions.

### CROSS REFERENCE TO RELATED APPLICATION

This application claims the benefit of U.S. Provisional Application No. 61/879,432 filed Sep. 13, 2013.

### FIELD OF THE INVENTION

The present invention relates generally to wagering game systems and control systems, including the security and integrity of the transactions stored on gaming systems or control systems.

### BACKGROUND OF THE INVENTION

Wager transactions are generally stored in a centralized gaming system that contains all wager information prior to a determining a winner. The party that maintains the wagers may be separate from the party selecting winning numbers and the party responsible for paying winners. A concern exists where the pool of wagers could be modified after a drawing to insert a winning wager or modify an existing wager to increase the prize amount thus allowing fraud to occur.

In an attempt to prevent wagers from being modified or inserted in the pool of wagers, there are instances where a copy of all the wagers is put into a control system of which the original party does not have access, and winners are determined using both the original pool of wagers and the copy. If a wager was inserted into either the original pool or the copy it would be evident when comparing details between the two systems.

There are times when the system housing the copy of wagers has not received all the transactions before the event used to determine the winners has occurred. This could be caused by various reasons such as hardware failure or communications related problems, but due to time constraints or other requirements the event must occur. An opportunity now exists where a transaction could be modified or inserted and then moved from the original pool of wagers to the copy. Subsequent processing of winners would match between the two systems.

Therefore, an objective of the present invention is to provide a method that can be used to identify tampering of any wager to increase a prize amount.

Another objective of the present invention is to provide a method of identifying tampering by insertion or addition of a winning wager.

A still further objective of the present invention is to provide a method of identifying tampering that is conducted within short time constraints.

These and other objectives will be apparent to one of ordinary skill in the art based upon the following written description, drawings, and claims.

### SUMMARY OF THE INVENTION

A method of identifying tampering in a pool of transactions includes receiving a plurality of transactions from a plurality of transaction points to a centralized control system. The centralized control system has a processor, software/algorithm, and a database or other data storage system and receives the plurality of transactions via an electronic network.

Once received, the processor uses the algorithm to create an identifier tag for each transaction. The identifier tag is based upon information from a current/active transaction and at least one preceding transaction. Optionally, the identifier tag can be based on a single transaction. Once assigned, information about the current transaction and the identifier tag are stored together or separately.

To verify a transaction, a reference tag is created using the same process as that used to create the identifier tag. The information used to create the reference tag can be from the original body of transactions, the copy of transactions or both. The processor then compares the reference tag to the stored identifier tags and/or information related to the identifier tags to determine if there is a match.

### BRIEF DESCRIPTION OF THE DRAWINGS

FIG. 1 is a schematic view of an environment for a method of identifying tampering;

FIG. 2 is a schematic view of an environment for a method of identifying tampering;

FIG. 3 is a schematic view of an environment for a method of identifying tampering; and

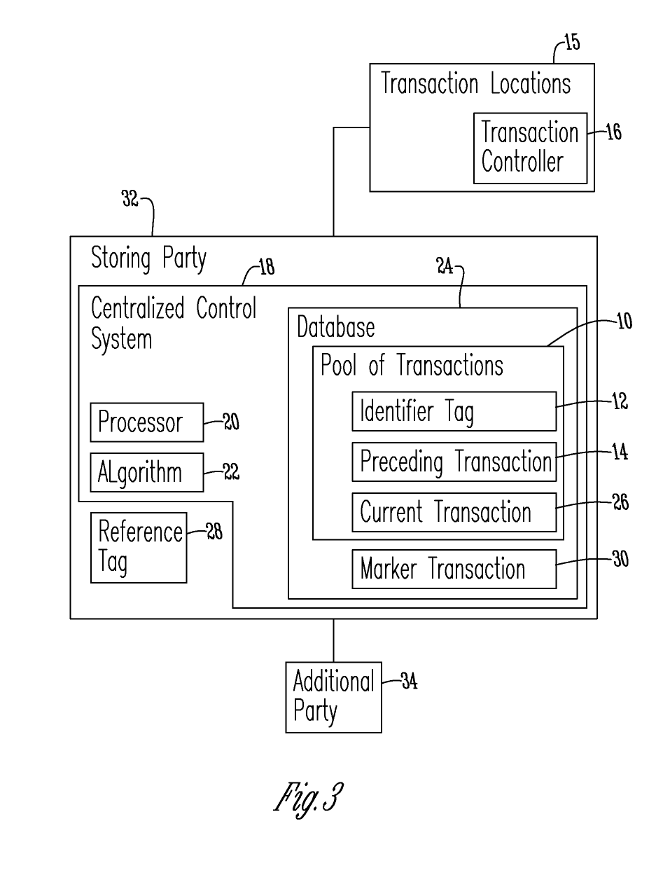

FIG. 4 is a flow diagram for a method of validating transactions or identifying tampering.

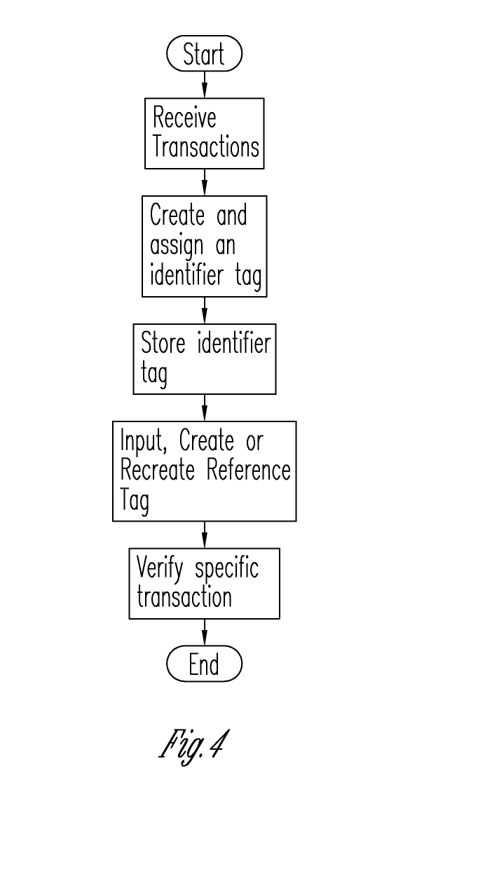

### DETAILED DESCRIPTION OF THE INVENTION

All illustrations of the drawings are for the purpose of describing selected versions of the present invention and are not intended to limit the scope of the present invention.

The subject matter disclosed herein relates generally to games of entertainment or chance, such as the lotteries or raffles, where transactions are stored in a single or combined pool on one or more computer systems and held until a drawing or event has occurred.

The present invention is a method for identifying tampering in a pool of transactions 10, such as wager transactions from a lottery system. This is accomplished by providing a tag 12 made using one-way hash functions, digital signatures or other any other symmetric or asymmetric encryption algorithm for each transaction, with the tag 12 being dependent on a variable amount of preceding transactions 14. The result is that tampering with a single transaction can be detected and using more proceeding transactions to create a tag 12 leads to a cascading effect, noticeably changing the tag 12 for each subsequent transaction that is linked to the tampered transaction. Properly implemented, a single modification can be detected in the entire set of wagers following the modified wager. The present invention is designed for use with a wagering system, such as used by lotteries, but can be implemented in any area where a series of transactions 10 need to be monitored for tampering. Though the preferred embodiment describes the use of hashes, any functionally equivalent cryptographic primitive may be used.

The plurality of transactions 10 can be made at a plurality of transaction points 15 or locations such as casinos, convenience stores, grocery stores, gas stations or other retail establishments or gaming establishments or the like. The transactions 10 are input into a transaction controller 16 that is connected to a centralized control system 18 via an electronic network. The centralized control system 18 includes a processor 20, software or an algorithm 22, and a database or other data storage system 24.

The basic embodiment of the present invention comprises the steps of receiving a plurality of transactions 10, creating an identifying tag 12 for each of the plurality of transactions 10 and verifying the identifying tag 12 of each of the plurality of transactions 10. The plurality of transactions comprises a variable plurality of preceding transactions 14 and an active or current transaction 26. After receiving and assigning the identifying tag 12 to a current transaction 26, the current transaction 26 or identifying tag 12 is stored separately or with the plurality of preceding transactions 14 in the database or other data storage system 24 and a new active transaction 26 is received. The process of creating the identifying tag 12 comprises the steps of executing an algorithm with the processor 20, outputting the identifying tag 12, and assigning the identifying tag 12 to the current transaction 26. The verification process comprises the steps of creating a reference tag 28 for a specific transaction, accessing the database or other data storage system 24 containing the corresponding identifying tag 12 for the specific transaction, and comparing the two to determine validity. If the reference tag 28 and identifying tag 12 do not match, then the system 18 determines that tampering has occurred with at least one of the plurality of transactions 10.

In order to link the plurality of transactions 10 together, identifying tags 12 from at least one of the plurality of preceding transactions 14 are input into the algorithm 22 when calculating the identifying tag 12 for a current transaction 26. In effect, the identifying tag 12 for a current transaction 26 is produced using details of at least one previous transaction 14. An identifying tag 12 created from a single transaction provides protection and using multiple transactions to create an identifying tag 12 provides the strongest protection. This step provides the ideal functionality of the present invention as tampering with any single transaction is evident in all subsequent transactions that use the tampered transaction as a reference input. Essentially, by linking the plurality of transactions 10 together, tampering with one transaction causes a domino effect in the linked transactions which is more easily detected. Potentially, a current transaction 26 can be linked to preceding transactions 14 directly by inputting details from the previous transaction 14 rather than inputting the identifying tags 12 from the preceding transactions 14.

While the above basic embodiment describes a plurality of transactions 10, improved embodiments further comprise a plurality of marker transactions 30, which act as special control transactions. The marker transactions 30 are used to create a known point of reference in the plurality of wagers relevant to preceding transactions 14 or subsequent transactions. For example, the marker transactions 30 can provide a time stamp, data about contents, or act as a benchmark (e.g. indicating how many previous transactions 14 were linked together in a group). In a sense, the function of the marker transaction 30 can be comparable to a salt. The marker transactions 30 can be created at any time and will be placed within the plurality of transactions 10 as they occur. The most common placements would include the beginning and end of a sales period. In this manner the marker transactions 30 can be used to create a known series of events to be used when determining if and when a system's copy of transactions has been tampered with. They provide a greater level of assurance that neither preceding nor subsequent transactions have been tampered with, either through modification or insertion. The marker transactions 30 can be of further use in the event of a system failure requiring the activation of a backup system or if the system 18 has an issue with transaction sequence numbers.

The process of the present invention is designed to be dynamic, allowing the system to balance security and speed. For example, when producing the identifying tag 12 for a current transaction 26, data could be pulled from a different number of preceding transactions 14. In addition, the data can be pulled from sequential preceding transactions or alternating preceding transactions (e.g. every other or every third transaction). Potentially, the selected preceding transactions 14 could be randomly determined. This flexibility is important as using more preceding transactions 14 increases the amount of time an algorithm 22 will take to run. In some industries, such as the lottery industry, transactions must be posted within a certain amount of time as set by the regulations. During times of high load a system 18 might not have enough resources to run algorithms 22 that use a large number of preceding transactions 14 used as inputs. The dynamic nature of the present invention allows the system 18 to reduce the number of preceding transactions 14 used as inputs in order to reduce the time for processing transactions. In this example of dynamic selection of preceding transactions 14, the pattern and quantity of preceding transactions 14 used may be stored with the transaction, the identifying tag or other location, whether encrypted or in clear text.

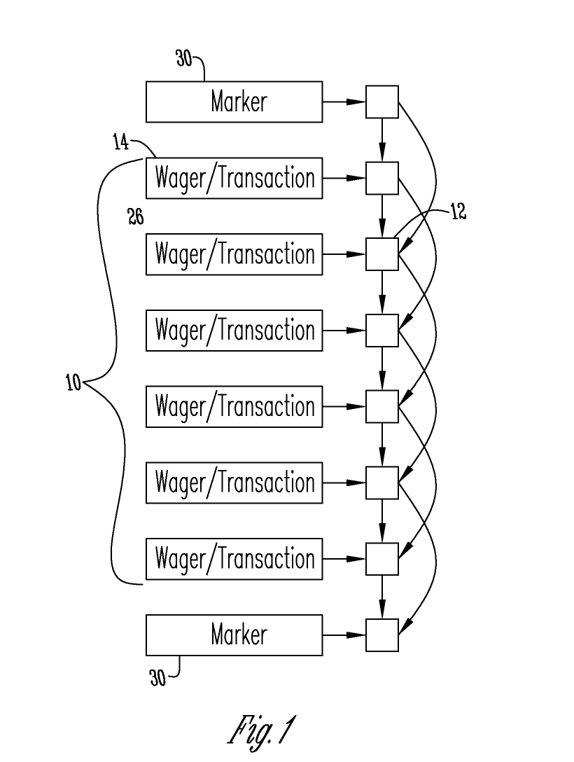

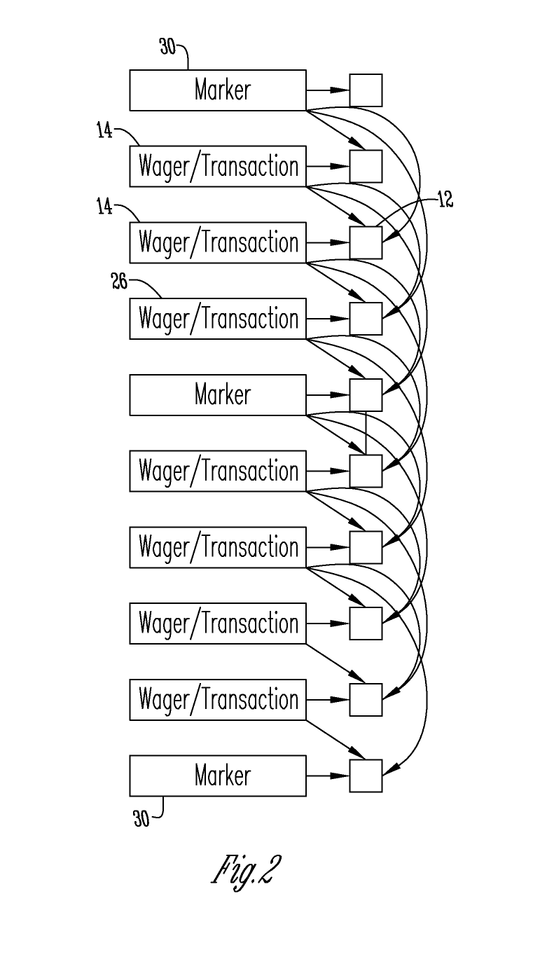

One example of the operation of the present invention is illustrated in FIG. 1. In this example, identifying tags 12 from previous transactions are used in the generation of the identifying tags 12 for the following two transactions. Resultantly, the tag 12 for each transaction is dependent upon the tags 12 of the previous two transactions 14. A variation is illustrated in FIG. 2, where the identifying tag 12 for each transaction is generated using the details of the previous three transactions 14. Unlike the first example, once generated, a tag 12 is not used for generation of future tags. These two examples show how variations of the present invention may be implemented while still utilizing the key concept of linking a current transaction 26 to previous transactions 14.

Although the invention has been explained in relation to its preferred embodiment, it is to be understood that many other possible modifications and variations can be made without departing from the spirit and scope of the invention.

What is claimed:

1. The method of identifying tampering in a pool of transactions, comprising the steps of:
receiving a plurality of transactions from a plurality of transaction points to a computer system having a processor, an algorithm, and a data storage system via an electronic network;
creating an identifier tag for each of the plurality of transactions using the algorithm and based upon a current transaction and information from a plurality of preceding transactions;
assigning the identifying tag to the current transaction using the processor and storing the identifier tag and the current transaction in at least one data storage system; and
verifying a specific transaction by creating a reference tag for a specific transaction using the computer system wherein the processor compares the reference tag with the stored identifier tag to determine if there is a match.

2. The method of claim 1 wherein the tag is encrypted from a group consisting of a one way hash function, a digital signature, a symmetric algorithm, an asymmetric algorithm, and cryptographic primitive.

3. The method of claim 1 further comprising the step of adding marker transactions within the plurality of transactions.

4. The method of claim 3 wherein the marker transaction is provided from a group consisting of a time stamp, data about contents, and a benchmark.

5. The method of claim 3 wherein the marker transaction is created at the beginning and an end of a sales period.
